(19) United States
(12) Patent Application Publication
(10) Pub. No.: US 2003/0123378 A1
(43) Pub. Date: Jul. 3, 2003

(54) Hybrid dual-sided DVD

(75) Inventors: Biing-Hwang Lin, Miao Li (TW); Chang-Juang Wu, Hsin Chu (TW)

Correspondence Address: QUINTERO LAW OFFICE, 1617 BROADWAY, 3RD FLOOR, SANTA MONICA, CA, 90404, US

(73) Assignee: Ritek Corporation

(21) Appl. No.: 10/331,859

(22) Filed: Dec. 30, 2002

(30) Foreign Application Priority Data
Dec. 31, 2001 (TW) 90133504

(51) Int. Cl. G11B 7/24

(52) U.S. Cl. 369/275.3; 369/283

(57) ABSTRACT

A hybrid dual-sided DVD. Recordable surfaces are respectively formed on each of the two sides thereof. Fabrication of the DVD utilizes the conventional steps of coating, gluing, sticking, and others, or uses other disc manufacturing techniques such as single-layered, two-to-one, or three-to-one to integrate a dual-sided DVD structure. The DVD conforms to one-time-only recordable, re-recordable, or other series types. The hybrid dual-sided DVD is able to carry un-rewriteable data on one side, while allowing an end user to record and/or re-record supplementary or complementary data on the reverse side, proving more convenient for information integration, delivery, and storage.

### BACKGROUND OF THE INVENTION

1. Field of the Invention

The present invention relates to a hybrid disk, and more specifically to a structure of a hybrid dual-sided digital versatile disk able to simultaneously support software prerecording and subsequent data write-in on a single disc.

2. Description of the Related Art

Digital versatile disks (DVD), whose specifications were initially unified at the end of 1995, are a new format of digital optical storage. DVD is able to store images, voices, and general data with the same function as the current video compact disc (VCD) is. Different formats of a DVD disc are developed for different applications, such as DVD-ROM (read-only memory), DVD-RAM (random access memory), DVD-R (recordable), DVD-Video, and others.

In addition to extending the storage capacity of a VCD from 74 minutes to 2 hours, DVD, according to the development in photoelectric technology, also offer superior image compression, developed from MPEG1 of the VCD to MPEG2 of the DVD. The resolution of images stored in the DVD is higher than those stored in other commercial media.

Prerecorded and recordable types comprise conventional DVDs, limiting application of the discs. Because a recordable optical disk may be written to, overwritten, destroyed, or carry viruses, it is a poor choice to carry commercial software or other data. Moreover, although a prerecorded optical disc is suitable for carrying the commercial software without over write concerns, additional supplementary or complementary data must be saved on an additional optical disc, increasing the possibility of lost or missing data.

Several kinds of industrial specifications exist for prerecorded DVDs, such as DVD-5, DVD-9, DVD-10, DVD-18, and others. The capacity of DVD-5, with a single-sided/single-layered structure, is approximately 4.7 GB; DVD-9, with a single-sided/dual-layered structure, approximately 8.5 GB; DVD-10, with a dual-sided/single-layered structure, approximately 9.4 GB; and DVD-18, with a dual-sided/dual-layered structure, as large as approximately 17 GB. The differences in capacities and structures among each of the aforementioned specifications are listed in TABLE 1 as follows.

TABLE 1
Capacities and structures among current DVD
specifications

| | Single- | Single- | Dual- | Dual- |
|---|---|---|---|---|
| | sided/single- | sided/dual- | sided/single- | sided/dual- |
| | layered | layered | layered | layered |
| DVD-5 | 4.7 GB | NO | NO | NO |
| DVD-9 | NO | 8.5 GB | NO | NO |
| DVD-10 | NO | NO | 9.4 GB | NO |
| DVD-18 | NO | NO | NO | 17 GB |

Thus, current DVD specifications can generally be divided into single-sided and dual-sided types. The capacity of dual-sided type is, as might be expected, twice as large as that of single-sided type. Additionally, the capacity of DVDs with a dual-layered structure is larger than those with a single-layered structure.

Conventional DVDs are generally divided into the following series types, based on their read-write function and capability.

The DVD-R one-time-only recordable optical disc series, with a capacity of approximately 4.7 GB, has a structure conforming to the DVD-5 specification. The DVD-R disc, however, has a recording layer between the substrate and the reflective layer. The recording layer is formed by the steps of dye coating, drying, and others, steps similar to those for a prerecorded general DVD.

The DVD-RW multi-recordable optical disc series can be rewritten approximately 1,000 times, with a structure similar to that of DVD-R. The recording layer of the DVD-RW disc, however, is of triple-layer composition, in which one of the three layers is formed by sputtering, with other steps similar to those for a prerecorded general DVD.

The DVD-RAM (digital versatile disc random access memory) multi-recordable optical disc series can be rewritten approximately 100,000 times and comprises single-sided/single-layered or dual-sided/single-layered structure, with respective capacities of 4.7 and 9.4 GB. The fabricating process for DVD-RAN is similar to that of a DVD-RW disc, differing only in the materials used and quantities of recording layers.

The HD-DVD (high density digital versatile disc) recordable optical disc series and prerecorded optical disc series while having a structure similar to DVD-5's single-sided/single-layered structure, has a capacity much larger than DVD-5's 4.7 GB, as large as approximately 10 GB-30 GB. The substrate thickness of the HD-DVD is approximately 0.6 mm, and the thickness of the final-finished HD-DVD is approximately 1.2 mm.

The DVR recordable optical disc series and prerecorded optical disc series have both one-time-only recordable and multi-recordable capabilities with sub-total thickness of the coating layer, recording layer, and reflective layer being approximately 0.1 mm, and a substrate thickness of approximately 1.1 mm, the total thickness of the DVR disc being approximately 1.2 mm.

Fabrication of a dual-sided optical disc is disclosed in U.S. Pat. No. 4,310,919, in which a method of prerecorded video and audio data on both sides of one optical disc to enlarge the capacity of the optical disc is disclosed. Further, a concrete method of fabricating a dual-layered optical disc is disclosed in U.S. Pat. No. 5,540,966, in which a dual-layered optical disc is fabricated by bonding two structural layers with different recording formats, on which data has been prerecorded respectively, so that both layers of the optical disc can provide the prerecorded data.

Moreover, U.S. Pat. No. 6,205,112 discloses another dual-sided optical disc structure, in which the format of one side is CD, which can be read by traditional CD drives and the other side is DVD, which can only be read by a DVD drive. The disclosure from this patent makes it practical to prerecord data in a format that can be read by a traditional CD drive and further prerecord data in another format with large capacity, which can be read by a DVD drive, to prerecord any data on one optical disc to meet demands for different disc formats readable by all types of CD drives.

Although U.S. Pat. No. 6,205,112 discloses a dual-sided optical disc with different formats on both sides, it is necessary to note that both sides of this optical disc are prerecorded, thus its application is still limited. International Publication No. WO 98/38637 is familiar with U.S. Pat. No. 6,205,112 that discloses a dual-aided DVD-CD whose sides both constitute unfinished prerecorded media.

In other words, dual-sided optical discs currently disclosed by U.S. Pat. No. 6,205,112 and international Publication No. WO 98/38637 carry different medium types on the two sides, but both sides are prerecorded, so additional supplementary or complementary data cannot be written to the same disc.

An ideal dual-faced DVD optical disc should give consideration to both requirements for the application of video-audio media and commercial software. Although optical disc structure having enormous capacity exists, currently, only the requirement for delivering existing video-audio media is taken into consideration.

### SUMMARY OF THE INVENTION

Thus, the main object of the present invention is to provide a dual-sided DVD structure allowing data to be prerecorded on one side and additional supplementary or complementary data to subsequently be recorded on the other side.

In accordance with the present invention, it is practical to fabricate the dual-sided DVD structure having one prerecorded and one recordable side by integrating a dual-sided DVD structure of prerecorded, one-time-only recordable, re-recordable, or other types with the process comprising conventional steps of coating, gluing, pressing, and others or with other disc manufacturing techniques such as single-piece, two-to-one, or three-to-one. Data can be prerecorded on one side of the dual-faced DVD, and additional supplementary or complementary data can subsequently be recorded on the other side by end users. Thus, it is convenient for information integration, delivery, and storage.

In addition, the present invention further provides a dual-sided DVD in which both sides are of different recordable type from each other, for example, one recordable DVR side, for use with a digital video recorder, and the other side recordable HD-DVD with high capacity, making it practical to record data in a digital video recorder and input or edit relative information on the same DVD by computer. Thus it is possible to integrate the information of a single event recorded by different apparatus into one single disc, making it more convenient to integrate all kinds of information.

### BRIEF DESCRIPTION OF THE DRAWINGS

The present invention can be more fully understood by reading the subsequent detailed- description in conjunction with the examples and references made to the accompanying drawings, wherein:

FIG. 1 is a cross-section illustrating the structure of a dual-sided DVD in accordance with the present invention.

### DETAILED DESCRIPTION OF THE INVENTION

The present invention discloses a dual-sided DVD structure having one side recordable and the other side recordable by the same or different specification types, respectively, integrating one-time-only recordable, multi-recordable, and other types. The fabrication process comprises the conventional steps of coating, gluing, pressing, and other steps, or using other disc manufacturing techniques such as single-faced, two-to-one, or three-to-one.

As in conventional DVDs, each side of the optical disc of the invention is formed by steps such as forming a reflective layer by sputtering on a substrate and gluing the substrate to another similarly or differently formed substrate,

The dual-sided DVD of the invention can also integrate a wide variety of the DVD series types based on read-write function, as detailed in the Prior Art.

First Embodiment

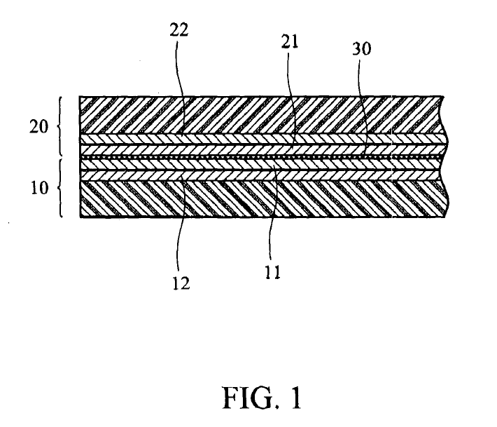

Referring to FIG. 1, a prerecorded disc 10, constituting one side of the DVD, in combined with a recordable disc (such as a DVD-R disc) 20 by coating, gluing, and pressing with a glue layer 30, to form a dual-sided DVD with one prerecorded side and the other side recordable.

The format of the prerecorded disc 10 can be selected from known specifications, such as DVD-5, DVD-9, DVD-10 (combining two DVD-5), and DVD-18 (as combining two DVD-9). There is a reflective layer 11 and a prerecorded layer 12 in the structure layers of the prerecorded disc 10, and at least a reflective layer 21 and a recording layer 22 in the structure layers of the recordable disc 20.

Second Embodiment

Composition of the prerecorded disc and the recordable disc in accordance with the present invention is detailed in TABLE 2. The prerecorded disc is a partially layered disc fabricated by mass production, using a roll-press.

TABLE 2
Possible compositional combinations of the
inventive dual-sided DVD (with “YES” indicating possible
combinations of specification and type)

| | | Partially | Partially |
|---|---|---|---|
| | | layered HD-DVD | layered DVR |
| | Partially | prerecorded | prerecorded |
| | layered DVD | disc | disc |
| Partially | YES | NO | NO |
| layered DVD-R | | | |
| recordable disc | | | |
| Partially | YES | NO | NO |
| layered DVD-RW | | | |
| recordable disc | | | |
| Partially | YES | NO | NO |
| layered DVD-RAM | | | |
| recordable disc | | | |
| Partially | YES | YES | YES |
| layered HD-DVD | | | |
| recordable disc | | | |
| DVR recordable | YES | YES | YES |
| disc | | | |

Third Embodiment

In accordance with the present invention, the prerecorded disc disclosed in the second embodiment can be replaced by a partially layered DVD-R, in combination with a partially layered DVD-R, HD-DVD, DVR, DVD-RW, or DVD-RAM.

The dual-sided DVD in this embodiment allows one-time-only recording of data to the DVD-R side and one-time-only or repeated recording to the other side, in accordance with the specification and type thereof. The DVD in this embodiment carries the same functionality as that of the previous embodiment, with the notable exception that it is a more practical equivalent embodiment for use by producers of smaller quantities, and those without roll-press manufacturing capability. In other words, the user is able to record data to the DVD-R side in the conventional fashion, while leaving the other side blank for end user recording and/or re-recording.

Fourth Embodiment

In addition to the other embodiments, the present invention further provides a dual-sided DVD having different recordable modes on both sides. For example, a dual-sided DVD has one DVR side, recordable by a digital video recorder, with the other side a HD-DVD recordable disc having large capacity. As an example, this DVD can make it practical to record data from a digital video recorder and subsequently input or edit relative information on the other side of the DVD by computer. This allows integration of information for a single event processed by different device technologies onto a single disc. The dual-sided DVD in this embodiment allows multi-time recording of data to the re-recordable side and one-time-only or repeated recording to the other side, in accordance with the specification and type thereof. The possible compositional combinations of the dual-sided DVD of this embodiment are listed in TABLE 3.

TABLE 3
Possible combinations at dual-sided DVD
structure in accordance with the fourth embodiment (with
“YES” indicating possible combinations of specification
and type)

| | Partially | Partially | Partially |
|---|---|---|---|
| | layered | layered | layered |
| | HD-DVD | DVD-RW | DVD-RAM |
| | recordable disc | recordable disc | recordable disc |
| Partially | YES | YES | YES |
| layered DVR | | | |
| recordable disc | | | |
| Partially | YES | NO | NO |
| layered DVD-RAM | | | |
| recordable disc | | | |
| Partially | YES | NO | YES |
| layered DVD-RW | | | |
| recordable disc | | | |

A dual-sided DVD in accordance with the present invention can be prerecorded with data on one side and be written or re-written with supplementary or complementary data on the other side by an end user. It also provides more convenient data collection and integration recorded by apparatus of different types and specifications on the same DVD.

Although the present invention has been particularly shown and described above with reference to four specific embodiments, it is anticipated that alterations and modifications thereof will no doubt become apparent to those skilled in the art. It is therefore intended that the following claims be interpreted as covering all such is alteration and modifications as fall within the true spirit and scope of the present invention.

What is claimed is:

1. A hybrid dual-sided DVD with structural layers comprising:
a first side, having a first reflective layer and a prerecorded layer recorded with data at the time of its manufacture;
a second side, having a second reflective layer and a recordable layer; and
a glue layer, fixing the layers to each other, such that a single disk is formed.

2. The hybrid dual-sided DVD as claimed in claim 1, wherein the first side comprises a partially layered DVD prerecorded, DVR prerecorded, or HD-DVD prerecorded series type.

3. The hybrid dual-sided DVD as claimed in claim 2, wherein, when the first side comprises a DVD prerecorded series type, the DVD conforms to the specifications of DVD-5 or DVD-9.

4. The hybrid dual-sided DVD as claimed in claim 1, wherein, when the first side comprises a DVD prerecorded series type, the second side comprises a partially layered DVD-R one-time-only recordable, DVD-RW re-recordable, DVD-RAM re-recordable, DVR one-time-only recordable, DVR re-recordable, HD-DVD one-time-only recordable, or HD-DVD re-recordable series type.

5. The hybrid dual-sided DVD as claimed in claim 1, wherein, when the first side comprises a HD-DVD prerecorded series type, the second side comprises a partially layered, DVR one-time-only recordable, DVR re-recordable, HD-DVD one-time-only recordable, or HD-DVD re-recordable series type.

6. The hybrid dual-sided DVD as claimed in claim 1, wherein, when the first side comprises a DVR prerecorded series type, the second side comprises a partially layered, DVR one-time-only recordable, DVR re-recordable, HD-DVD one-time-only recordable, or HD-DVD re-recordable series type.

7. A hybrid dual-sided DVD with structural layers of differing DVD series type, comprising:
a first side, having a first reflective layer and a one-time-only recordable layer;
a second side, having a second reflective layer and a recordable layer; and
a glue layer, fixing the layers to each other, such that a single disk is formed.

8. The hybrid dual-sided DVD as claimed in claim 7, wherein the first side comprises the DVD-R one-time-only recordable series type.

9. The hybrid dual-sided DVD as claimed in claim 7, wherein the second side comprises a DVD-RW re-recordable, DVR one-time-only recordable, DVR re-recordable, HD-DVD one-time-only recordable, HD-DVD re-recordable, or DVD-RAM re-recordable series type.

10. A hybrid dual-sided DVD with structural layers of differing DVD series type, comprising:
a first side, having a first reflective layer and a recordable layer;
a second side, having a second reflective layer and a recordable layer; and
a glue layer, fixing the layers to each other, such that a single disk is formed.

11. The hybrid dual-sided DVD as claimed in claim 10, wherein the first side comprises the DVR one-time-only recordable series type, and the second side comprises a DVD-RW re-recordable, HD-DVD one-time-only recordable, HD-DVD re-recordable or DVD-RAM re-recordable series type.

12. The hybrid dual-sided DVD as claimed in claim 10, wherein the first side comprises the DVR re-recordable series type, and the second side comprises a DVD-RW re-recordable, HD-DVD one-time-only recordable, HD-DVD re-recordable, or DVD-RAM re-recordable series type.

13. The hybrid dual-sided DVD as claimed in claim 10, wherein the first side comprises the DVD-DVD one-time-only recordable series type, and the second side comprises a DVR one-time-only recordable, DVR re-recordable, DVD-RW re-recordable, or DVD-RAM re-recordable series type.

14. The hybrid dual-aided DVD as claimed in claim 10, wherein the first side comprises the HD-DVD re-recordable series type, and the second side comprises a DVR one-time-only recordable, DVR re-recordable, DVD-RW re-recordable, or DVD-RAM re-recordable series type.

15. The hybrid dual-sided DVD as claimed in claim 10, wherein the first side comprises the DVD-RW re-recordable series type, and the second side comprises a DVR one-time-only recordable, DVR re-recordable, or DVD-RAM re-recordable series type.

16. The hybrid dual-sided DVD as claimed in claim 10, wherein the first side comprises the DVD-RAM re-recordable series type, and the second side comprises a DVR one-time-only recordable, DVR re-recordable, or DVD-RW re-recordable series type.
